(19) United States
(12) Patent Application Publication
(10) Pub. No.: US 2010/0001440 A1
(43) Pub. Date: Jan. 7, 2010

(54) METHOD OF MAKING A CONTAINER HAVING BLOWN POUR SPOUT

(75) Inventors: Michael E. Penny, Saline, MI (US); Dan Weissmann, Simsbury, CT (US)

Correspondence Address: HARNESS, DICKEY & PIERCE, P.L.C., P.O. BOX 828, BLOOMFIELD HILLS, MI, 48303, US

(73) Assignee: AMCOR LIMITED, Abbotsford (AU)

(21) Appl. No.: 12/546,175

(22) Filed: Aug. 24, 2009

Related U.S. Application Data
(63) Continuation of application No. 11/369,937, filed on Mar. 7, 2006, now abandoned.

(51) Int. Cl. B29C 49/00

(52) U.S. Cl. 264/533

(57) ABSTRACT

A method of making a one-piece plastic container includes disposing a preform into a mold cavity having a mold surface. Blowing the preform against the mold surface to form an intermediate container. The intermediate container having a body portion, a spout and a moil portion. An intersection between the spout and the moil portion defines a cutting plane extending at an angle. Severing the moil portion from the spout at the intersection thereby defining an opening into the container at the spout.

### CROSS-REFERENCE TO RELATED APPLICATION

This application is a continuation of U.S. patent application Ser. No. 11/369,937 filed on Mar. 7, 2006, the entire disclosure of which is incorporated herein by reference.

### TECHNICAL FIELD

This disclosure generally relates to a method of making plastic containers for retaining a commodity, such as a solid or liquid commodity. More specifically, this disclosure relates to a method of making a one-piece blown container having a pour spout arranged at an angle relative to a longitudinal axis of the container.

### BACKGROUND

As a result of environmental and other concerns, plastic containers, more specifically polyester and even more specifically polyethylene terephthalate (PET) containers are now being used more than ever to package numerous commodities previously supplied in glass containers. Manufacturers and fillers, as well as consumers, have recognized that PET containers are lightweight, inexpensive, recyclable and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{a}}{{ρ}_{c} - {ρ}_{a}} ) \times 100$$

where ρ is the density of the PET material; ρₐ is the density of pure amorphous PET material (1.333 g/cc); and ρ_{c} is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching an injection molded PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having biaxial molecular orientation. The thermal processing of an oriented PET container, which is known as heat setting, typically includes blow molding a PET preform against a mold heated to a temperature of approximately 250° F.-350° F. (approximately 121° C.-177° C.), and holding the blown container against the heated mold for approximately two (2) to five (5) seconds. Manufacturers of PET juice bottles, which must be hot-filled at approximately 185° F. (85° C.), currently use heat setting to produce PET bottles having an overall crystallinity in the range of approximately 25%-35%.

Typically, an upper portion of the plastic container defines an opening. This upper portion is commonly referred to as a finish and includes some means for engaging a cap or closure to close off the opening. In the traditional injection-stretch blow molding process, the finish remains substantially in its injection molded state while the container body is formed below the finish. The finish may include at least one thread extending radially outwardly around an annular sidewall defining a thread profile. In one application a closure member or cap may define a complementary thread, or threads, that are adapted to cooperatively mate with the threads of the finish.

In addition, an alternative method may be used to form the finish portion of the container. This alternative method is known as a blown finish. During this alternative process, the finish portion of the container is created in the blow mold utilizing a process similar to the blow molding process described above. This alternative process enables production of a lighter-weight finish portion, and thus container, then is possible through the traditional injection molding production method. Additionally, when produced utilizing a heat setting process, a blown finish may provide superior heat resistance characteristics as compared to traditional injection molded finishes.

In some applications it is desirable to provide a spout at the opening of the container. In one example, a spout may be formed as a secondary component and subsequently connected to a container after the container has been blown. In many instances, the spout, once connected to the container, may define an angle relative to a longitudinal axis of the container to facilitate pouring. While a container having an angled spout improves functionality of the container such as during pouring, the two piece design requires significant material and manufacturing costs. Thus, there is a need for a one-piece container design that has a pourable spout feature incorporated into the finish of the container.

### SUMMARY

Accordingly, the present disclosure provides a one-piece plastic container having a body defining a longitudinal axis. The body includes an upper portion, a sidewall portion and a base portion. The upper portion includes a spout defining an opening into the container. The sidewall portion is integrally formed with and extends from the upper portion to the base portion. The base portion closes off an end of the container. The spout extends at an angle relative to the longitudinal axis.

According to other features, the upper portion includes a finish defining at least one thread thereon. Alternatively, the finish portion may include other means for accommodating a closure such as a flange or groove for engagement of the closure onto the container. The spout is radially stepped in relative to the finish. The spout extends from a land formed at a transition between the finish and the spout. The spout defines a continuous radial sidewall extending from the land in a direction toward a longitudinal plane of the body. The spout is angled from a high end to a low end. The high end defines a dispensing end. The opening is generally narrower near the dispensing end.

According to yet other features, the spout extends from a radial trough formed at a transition between the finish and the spout. The trough defines a passage into the container.

A method of making a blow-molded plastic container includes disposing a preform into a mold cavity. The mold cavity has a surface defining a body forming region, a moil forming region and a spout forming region interposed between the body forming region and the moil forming region. The preform is blown against the mold surface to form an intermediate container having a body portion, a spout and a moil portion. The body portion defines a longitudinal axis. An intersection between the spout and the moil portion defines a cutting plane extending at an angle relative to the longitudinal axis. The moil portion is severed from the spout at the intersection thereby defining an opening into a resultant container at the spout.

According to additional features, the moil portion defines at least two parallel radial rib forming portions. The rib forming portions are parallel to the cutting plane and serve to support the intermediate container during and throughout a trimming process. Blowing the preform may include forming a trough radially around a transition between the spout and a finish of the container. A passage may be subsequently formed in the trough.

Additional benefits and advantages of the present disclosure will become apparent to those skilled in the art to which the present disclosure relates from the subsequent description and the appended claims, taken in conjunction with the accompanying drawings. It will also be appreciated by those skilled in the art to which the present disclosure relates that the container of the present disclosure may be manufactured utilizing alternative blow molding processes to those disclosed above.

### BRIEF DESCRIPTION OF THE DRAWINGS

FIG. 1 is a side elevational view of a one-piece plastic container constructed in accordance with the teachings of the present disclosure.

FIG. 2 is a rear elevational view of an upper portion of the container of FIG. 1.

FIG. 3 is a top view of the container of FIG. 1.

FIG. 4 is a sectional view of an exemplary mold cavity used during formation of the container of FIG. 1 and shown with a preform positioned therein.

FIG. 5 is a side elevational view of an intermediate container constructed in accordance with the teachings of the present disclosure.

FIG. 6 is a front elevational view of the intermediate container shown in FIG. 5; and

FIG. 7 is a partial sectional view of an upper portion of a container constructed in accordance with additional features of the present disclosure.

### DETAILED DESCRIPTION

The following description is merely exemplary in nature, and is in no way intended to limit the disclosure or its application or uses.

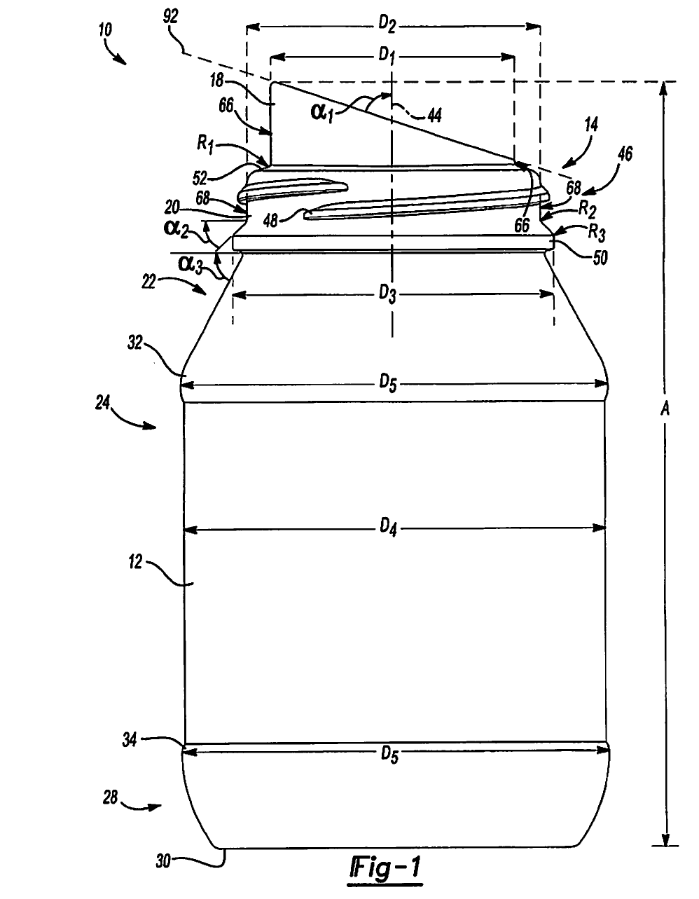

FIGS. 1-3 show one preferred embodiment of the present container. In the Figures, reference number 10 designates a one-piece plastic, e.g. polyethylene terephthalate (PET), container. As shown in FIG. 1, the container 10 has an overall height A of about 177.10 mm (6.97 inch). As shown in FIG. 3, the container 10 is substantially cylindrical in cross section. In this particular embodiment, the container 10 has a volume capacity of about 1 Liter (1000 cc). Those of ordinary skill in the art would appreciate that the following teachings of the present disclosure are applicable to other containers, such as rectangular, triangular, hexagonal, octagonal or square shaped containers, which may have different dimensions and volume capacities. It is also contemplated that other modifications can be made depending on the specific application and environmental requirements.

As shown in FIGS. 1-3, the one-piece plastic container 10 according to the present teachings defines a body 12, and includes an upper portion 14 having a spout 18 and a finish 20. Integrally formed with the finish 20 and extending downward therefrom is a shoulder region 22. The shoulder region 22 merges into and provides a transition between the finish 20 and a sidewall portion 24. The sidewall portion 24 extends downward from the shoulder region 22 to a base portion 28 having a base 30. An upper bumper portion 32 may be defined at a transition between the shoulder region 22 and the sidewall portion 24. A lower bumper portion 34 may be defined at a transition between the base portion 28 and the sidewall portion 24.

Those skilled in the art know and understand that a neck (not illustrated) may also be included having an extremely short height, that is, becoming a short extension from the finish 20, or an elongated height, extending between the finish 20 and the shoulder region 22. The plastic container 10 has been designed to retain a commodity. The commodity may be in any form such as a solid or liquid product. In one example, a liquid commodity may be introduced into the container during a thermal process, typically a hot-fill process. For hot-fill bottling applications, bottlers generally fill the container 10 with a liquid or product at an elevated temperature between approximately 155° F. to 205° F. (approximately 68° C. to 96° C.) and seal the container 10 with a closure (not illustrated) before cooling. In addition, the plastic container 10 may be suitable for other high-temperature pasteurization or retort filling processes or other thermal processes as well. In another example, the commodity may be introduced into the container under ambient temperatures.

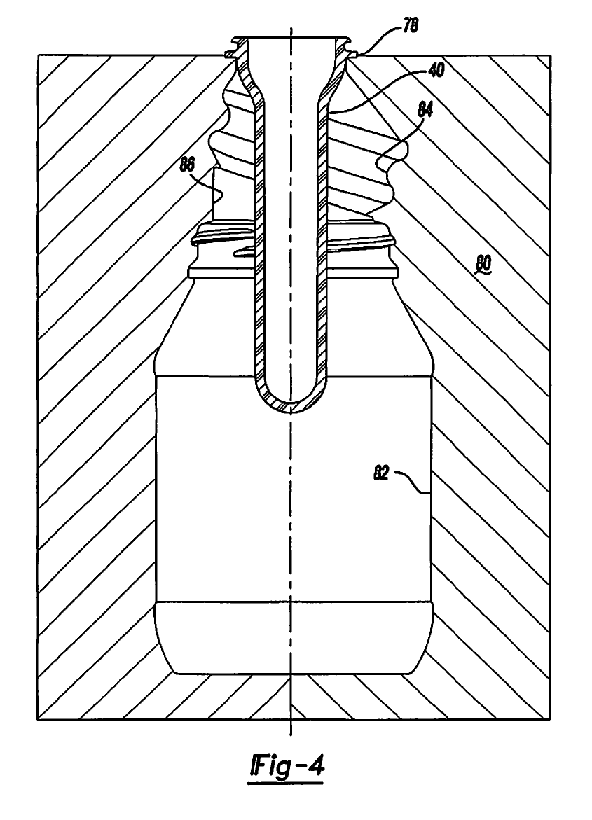

The plastic container 10 of the present disclosure is a blow molded, biaxially oriented container with a unitary construction from a single or multi-layer material. A well-known stretch-molding, heat-setting process for making the one-piece plastic container 10 generally involves the manufacture of a preform 40 (FIG. 4) of a polyester material, such as polyethylene terephthalate (PET), having a shape well known to those skilled in the art similar to a test-tube with a generally cylindrical cross section and a length typically approximately fifty percent (50%) that of the container height. An exemplary method of manufacturing the plastic container 10 will be described in greater detail later.

Returning now to FIGS. 1-3, the spout 18 defines an opening 42. The spout 18 extends at an angle α₁ relative to a longitudinal axis 44 of the container 10. In one example, α₁ may be approximately 72 degrees. Explained differently, the spout 18 may define an angle of approximately 18 degrees relative to the base 30. It is appreciated that other angles may be used. The spout 18 assists in channeling, funneling and/or metering the commodity as it is poured from the container 10 through the opening 42. The finish 20 of the plastic container 10 includes a threaded region 46 having threads 48, and a lower sealing ridge 50. The threaded region 46 provides a means for attachment of a similarly threaded closure or cap (not illustrated). Alternatives may include other suitable devices that engage the finish 20 of the plastic container 10. Accordingly, the closure or cap (not illustrated) engages the finish 20 to preferably provide a hermetical seal of the plastic container 10. The closure or cap (not illustrated) is preferably of a plastic or metal material conventional to the closure industry and suitable for subsequent thermal processing, including high temperature pasteurization and retort.

A land 52 is formed radially at a transition between the finish 20 and the spout 18. In this way, the spout 18 is radially stepped inward relative to the finish 20. The spout 18 defines a continuous radial sidewall 56 extending from the land 52 in a direction toward a longitudinal plane 60 (FIG. 3) defined through the longest portion of the opening 42 on the body 12 of the container 10. The spout 18 is angled upward from a low end 62 to a high end 64. The high end 64 defines a dispensing end during use. As viewed from FIGS. 1 and 3, the spout 18 defines a first pair of lateral walls 66 at the longitudinal plane 60 and a second pair of lateral walls 68 at the finish 20. The first and second pairs of lateral walls 66 and 68 are parallel to one another.

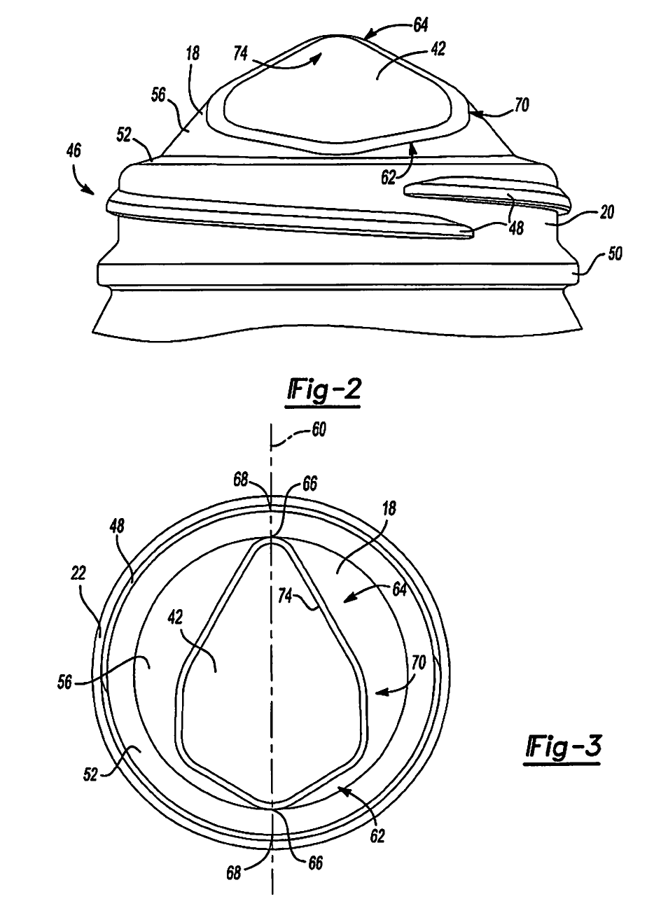

With specific reference to FIGS. 2 and 3, the opening 42 of the spout 18 generally defines an intermediate portion 70 between the high end 64 and the low end 62. As shown, the opening 42 of the spout 18 is wider at the intermediate portion 70 relative to the high end 64 and the low end 62. The opening 42 sweeps more gradually toward the longitudinal plane 60 through the high end 64 as compared to the low end 62.

During use, the container 10 may be tipped counter-clockwise as viewed from FIG. 1 thereby directing the commodity toward a pouring groove 74 (FIGS. 2 and 3) at the high end 64 when pouring. In this way, the pouring groove 74 of the spout 18 may direct the commodity in a controlled, metered manner when poured from the container 10. In one example, a handle (not shown) may be provided on the sidewall portion 24 opposite the high end 64 to facilitate tipping of the container 10 during pouring.

With continued reference now to FIGS. 1-3, exemplary dimensions for the upper portion 14 will be described. It is appreciated that other dimensions may be used. A diameter D₁ of the spout 18 may be 50.8 mm (2 inch). A diameter D₂ of the finish 20 may be 67.46 mm (2.66 inch). A diameter D₃ of the lower sealing ridge 50 may be 73.91 mm (2.91 inch). The body 12 may define a diameter D₄ of 96.27 mm (3.79 inch) at a label portion. A diameter D₅ of the upper and lower bumper portions 32 and 34, respectively, may be 97.79 mm (3.85 inch). An angle α₂ at which the lower sealing ridge 50 extends from a line perpendicular to the finish 20 may be about 45 degrees. An angle α₃ the shoulder region 22 extends from a line perpendicular to the finish 20 may be about 62 degrees. A radius R₁ between the land 52 and the spout 18 may be 1.02 mm (0.04 inch). Radii R₂ and R₃ defined at the transition between the finish 20 and the lower sealing ridge 50 may be 1.52 mm (0.06 inch).

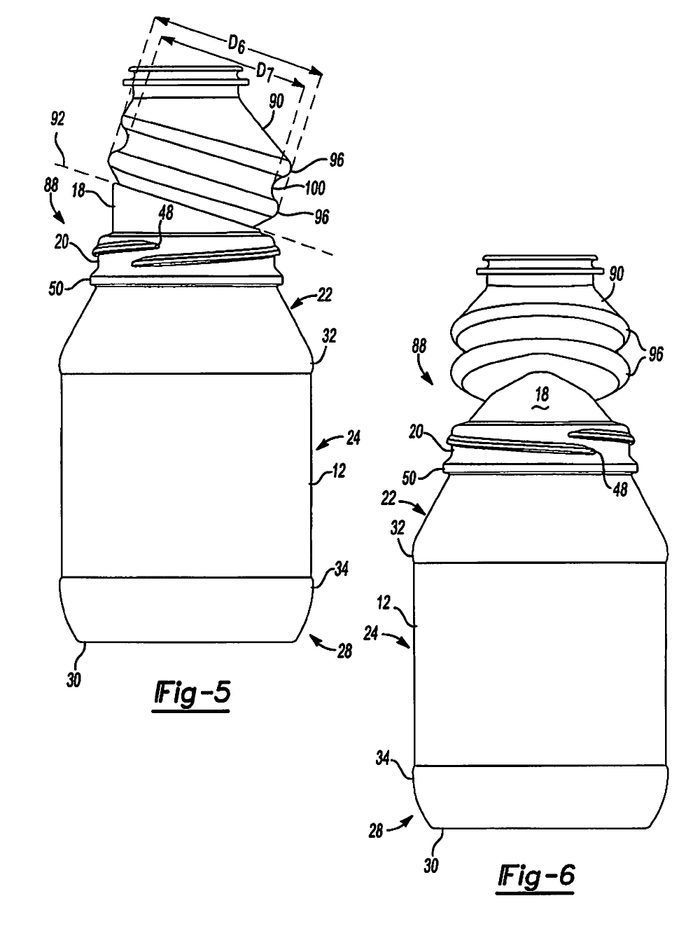

Turning now to FIG. 4, an exemplary method of forming the container 10 will be described. At the outset, the preform 40 may be placed into a mold cavity 80. In general, the mold cavity 80 has an interior surface corresponding to a desired outer profile of the blown container. More specifically, the mold cavity 80 according to the present teachings defines a body forming region 82, a moil forming region 84 and a spout forming region 86. The resultant structure, hereinafter referred to as an intermediate container 88, is illustrated in FIGS. 5 and 6 and generally includes a moil 90, the spout 18 and the body 12. The preform 40 (FIG. 4) includes a support ring 78, which may be used to carry or orient the preform 40 through and at various stages of manufacture. For example, the preform 40 may be carried by the support ring 78, the support ring 78 may be used to aid in positioning the preform 40 in the mold cavity 80, or the support ring 78 may be used to carry the intermediate container 88 once blow molded.

In one example, a machine (not illustrated) places the preform 40 heated to a temperature between approximately 190° F. to 250° F. (approximately 88° C. to 121° C.) into the mold cavity 80. The mold cavity 80 may be heated to a temperature between approximately 250° F. to 350° F. (approximately 121° C. to 177° C.). A stretch rod apparatus (not illustrated) stretches or extends the heated preform 40 within the mold cavity 80 to a length approximately that of the intermediate container 88 thereby molecularly orienting the polyester material in an axial direction generally corresponding with the central longitudinal axis 44 of the container 10. While the stretch rod extends the preform 40, air having a pressure between 300 PSI to 600 PSI (2.07 MPa to 4.14 MPa) assists in extending the preform 40 in the axial direction and in expanding the preform 40 in a circumferential or hoop direction thereby substantially conforming the polyester material to the shape of the mold cavity 80 and further molecularly orienting the polyester material in a direction generally perpendicular to the axial direction, thus establishing the biaxial molecular orientation of the polyester material in most of the intermediate container 88. The pressurized air holds the mostly biaxial molecularly oriented polyester material against the mold cavity 80 for a period of approximately two (2) to five (5) seconds before removal of the intermediate container 88 from the mold cavity 80. This process is known as heat setting and results in a heat-resistant container suitable for filling with a product at high temperatures.

In another example, a machine (not illustrated) places the preform 40 heated to a temperature between approximately 185° F. to 239° F. (approximately 85° C. to 115° C.) into the mold cavity 80. The mold cavity 80 may be chilled to a temperature between approximately 32° F. to 75° F. (approximately 0° C. to 24° C.). A stretch rod apparatus (not illustrated) stretches or extends the heated preform 40 within the mold cavity 80 to a length approximately that of the intermediate container 88 thereby molecularly orienting the polyester material in an axial direction generally corresponding with the central longitudinal axis 44 of the container 10. While the stretch rod extends the preform 40, air having a pressure between 300 PSI to 600 PSI (2.07 MPa to 4.14 MPa) assists in extending the preform 40 in the axial direction and in expanding the preform 40 in a circumferential or hoop direction thereby substantially conforming the polyester material to the shape of the mold cavity 80 and further molecularly orienting the polyester material in a direction generally perpendicular to the axial direction, thus establishing the biaxial molecular orientation of the polyester material in most of the intermediate container 88. The pressurized air holds the mostly biaxial molecularly oriented polyester material against the mold cavity 80 for a period of approximately two (2) to five (5) seconds before removal of the intermediate container 88 from the mold cavity 80. This process is utilized to produce containers suitable for filling with product under ambient conditions or cold temperatures.

Alternatively, other manufacturing methods using other conventional materials including, for example, polyethylene naphthalate (PEN), a PET/PEN blend or copolymer, and various multilayer structures may be suitable for the manufacture of plastic container 10. Those having ordinary skill in the art will readily know and understand plastic container manufacturing method alternatives.

Once the intermediate container 88 has been formed, the intermediate container 88 may be removed from the mold cavity 80. As can be appreciated, the intermediate container 88 defines the container 10 (FIG. 1) and the moil 90 prior to formation of the opening 42 (FIG. 3). An intersection between the spout 18 and the moil 90 defines a cutting plane 92 (FIG. 5). The cutting plane 92 corresponds to the angle α₁ of the spout 18. The moil 90 is subsequently severed from the spout 18 at the cutting plane 92. The severing process may be any suitable cutting procedure that removes the moil 90 and creates the opening 42.

The moil 90 generally defines a pair of parallel radial ribs 96. The radial ribs 96 may be oriented in a direction parallel to the cutting plane 92. Interposed between the radial ribs 96 is a channel 100 that may be used to facilitate transport and/or orientation of the intermediate container 88 during the severing step. In one example, a belt drive may locate between the radial ribs 96 at the channel 100 during manipulation of the intermediate container 88 prior to and/or during severing.

With reference now to FIGS. 5 and 6, exemplary dimensions for the moil 90 will be described. It is appreciated that other dimensions may be used. A diameter D₆ of 68.00 mm (2.68 inch) may be defined at the radial ribs 96. A diameter D₇ of 58.50 mm (2.30 inch) may be defined at the channel 100.

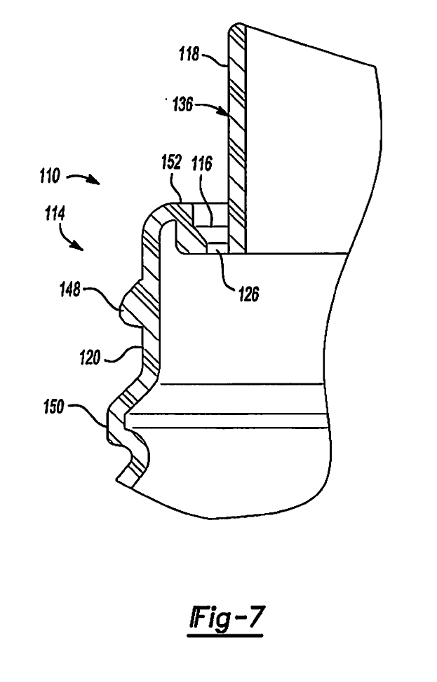

With reference now to FIG. 7, an upper portion 114 of a container 110 formed according to additional features is shown. The container 110 includes similar features as the container 10, which are referred to with like reference numerals increased by 100. A radial trough 116 is formed at the intersection between a spout 118 and a finish 120. The trough 116 defines a passage 126 adapted to drain remnants of the commodity that may have dripped along an outer surface 136 of the spout 118 (such as during pouring) back into the container 110. The passage 126 may be formed in the trough 116 through a subsequent stamping or cutting step after the intermediate container 88 has been formed.

While the above description constitutes the present disclosure, it will be appreciated that the disclosure is susceptible to modification, variation and change without departing from the proper scope and fair meaning of the accompanying claims.

What is claimed is:

1. A method of making a blow-molded plastic container comprising:
disposing a preform into a mold cavity having a surface defining a body forming region, a moil forming region and a spout forming region interposed between said body forming region and said moil forming region;
blowing said preform against said mold surface to form an intermediate container having a body portion, a spout and a moil portion, wherein said body portion defines a longitudinal axis and wherein an intersection between said spout and said moil portion defines a cutting plane extending at an angle relative to said longitudinal axis; and
severing said moil portion from said spout at said intersection thereby defining an opening into the container at said spout.

2. The method of claim 1 wherein said moil portion defines at least two parallel radial rib forming portions.

3. The method of claim 2 wherein said rib forming portions are generally parallel to said cutting plane.

4. The method of claim 1 wherein severing said moil portion includes forming said spout having a high end and a low end, said high end defining a dispensing end.

5. The method of claim 4 wherein blowing said preform further includes forming a trough radially around a transition between said spout and a finish of the container.

6. The method of claim 5 further comprising forming a passage in the container through said trough.

7. The method of claim 1 wherein said cutting plan angle relative to said longitudinal axis measures approximately 72 degrees.

8. A method of making a blow-molded plastic container comprising:
disposing a heated preform into a heated mold cavity having a surface defining a body forming region, a moil forming region and a spout forming region interposed between said body forming region and said moil forming region;
blowing said heated preform against said mold surface to form an intermediate container having a body portion, a spout and a moil portion, wherein said body portion defines a longitudinal axis and wherein an intersection between said spout and said moil portion defines a cutting plane extending at an angle relative to said longitudinal axis; and
severing said moil portion from said spout at said intersection thereby defining an opening into the container at said spout.

9. The method of claim 8 wherein said heated preform is heated to a temperature between approximately 190° F. to 250° F. (approximately 88° C. to 121° C.).

10. The method of claim 9 wherein said heated mold cavity is heated to a temperature between approximately 250° F. to 350° F. (approximately 121° C. to 177° C.).

11. The method of claim 10 wherein the step of blowing said heated preform against said mold surface lasts for a period of approximately two (2) to five (5) seconds.

12. The method of claim 11 wherein said moil portion defines at least two parallel radial rib forming portions which are generally parallel to said cutting plane, and a channel interposed therebetween.

13. The method of claim 11 wherein severing said moil portion includes forming said spout having a high end and a low end, said high end defining a dispensing end.

14. The method of claim 11 wherein said cutting plane angle relative to said longitudinal axis measures approximately 72 degrees.

15. A method of making a blow-molded plastic container comprising:
disposing a heated preform into a chilled mold cavity having a surface defining a body forming region, a moil forming region and a spout forming region interposed between said body forming region and said moil forming region;
blowing said heated preform against said mold surface to form an intermediate container having a body portion, a spout and a moil portion, wherein said body portion defines a longitudinal axis and wherein an intersection between said spout and said moil portion defines a cutting plane extending at an angle relative to said longitudinal axis; and
severing said moil portion from said spout at said intersection thereby defining an opening into the container at said spout.

16. The method of claim 15 wherein said heated preform is heated to a temperature between approximately 185° F. to 239° F. (approximately 85° C. to 115° C.).

17. The method of claim 16 wherein said chilled mold cavity is chilled to a temperature between approximately 32° F. to 75° F. (approximately 0° C. to 24° C.).

18. The method of claim 17 wherein the step of blowing said heated preform against said mold surface lasts for a period of approximately two (2) to five (5) seconds.

19. The method of claim 18 wherein said moil portion defines at least two parallel radial rib forming portions which are generally parallel to said cutting plane, and a channel interposed therebetween.

20. The method of claim 18 wherein severing said moil portion includes forming said spout having a high end and a low end, said high end defining a dispensing end.

21. The method of claim 18 wherein said cutting plane angle relative to said longitudinal axis measures approximately 72 degrees.
